(19) United States
(12) Patent Application Publication
(10) Pub. No.: US 2001/0037462 A1
(43) Pub. Date: Nov. 1, 2001

(54) Method and apparatus for obtaining a printed copy of a document via the internet

(76) Inventor: Michael B. Bengtson, Frankfort, IL (US)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/771,909

(22) Filed: Jan. 29, 2001

Related U.S. Application Data
(60) Provisional application No. 60/201,554, filed on May 1, 2000.

(51) Int. Cl. H04L 9/00

(52) U.S. Cl. 713/201

(57) ABSTRACT

A system for obtaining a printed copy of a copyrighted document via the Internet is provided. The copyrighted document is encrypted at a server using a particular public encryption key. The encrypted document is then transmitted to a destination printer. The destination printer includes a private encryption key which corresponds to the public encryption key. The private encryption key is unavailable outside the printer. For example, a client computer attached to the printer may not read the private encryption key. Once the encrypted document is received, the printer decrypts the copyrighted document inside the printer prior to printing in order to frustrate redistribution of the copyrighted document.

### RELATED APPLICATION

This application claims priority from provisional application serial No. 60/201,554 filed May 1, 2000.

### TECHNICAL FIELD

The present system relates in general to a method and apparatus for obtaining a printed copy of a document via the Internet and in particular to decrypting a copyrighted or confidential document inside a printer in order to frustrate redistribution of the document.

### BACKGROUND

With increased use of the Internet and other information services, more people are downloading copyrighted and confidential content. Often, these people find that viewing the content at a computer is inconvenient and prefer to print documents for subsequent review. In fact, many users have such a strong preference for the printed page that, despite the convenience of downloading a copy form the Internet, they continue to purchase a paper copy.

Typically, downloaded content includes advertisements to subsidize the cost of producing the content. This advertising is tolerated in some circumstances (e.g., the daily news), but often, frequent advertising is not tolerated in other circumstances (e.g., a 200 page novel). As a result, many people prefer to purchase a paper copy.

Some attempts have been made to provide downloadable “e-books” which do not include advertisements. Instead of advertisements, the e-book is purchased like a paper book. However, these prior art approaches suffer form certain drawbacks to the publisher, the consumer, or both. In some systems, copyrighted/confidential material is simply sent to the consumer's client device when purchased without using any encryption. In other systems, the copyrighted/confidential material is encrypted at a server and decrypted at the client device. In either case, a non-encrypted version of the copyrighted/confidential material resides on the consumer's client device. As a result, unscrupulous consumers may transmit the copyrighted/confidential material to other user's who have not paid the copyright owner and/or should not be allowed to view the confidential material. Even if a password is required to read the material, the password may be shared with other user's.

In other systems, the copyrighted/confidential material may only be viewed on a proprietary viewing device which is not capable of transmission. However, some of these systems do not allow printing of a paper copy. Other devices do allow printing, but the print signal is transmitted from an output port to a standard printer. This signal is not encrypted and is therefore susceptible to interception and retransmission.

### BRIEF DESCRIPTION OF THE DRAWINGS

Features and advantages of the present invention will be apparent to those of ordinary skill in the art in view of the detailed description of the preferred embodiments which is made with reference to the drawings, a brief description of which is provided below.

FIG. 1 is a high level block diagram of a communications system.

FIG. 2 is a more detailed block diagram of one of the document servers illustrated in FIG. 1.

FIG. 3 is a more detailed block diagram of one of the client devices illustrated in FIG. 1.

FIG. 4 is a more detailed block diagram of one of the printers illustrated in FIG. 1.

FIG. 5 is a flowchart of a process for transmitting a copyrighted or confidential document from the content server of FIG. 2 to the printer of FIG. 4 via the client device of FIG. 3

### DETAILED DESCRIPTION OF THE PREFERRED EMBODIMENTS

In general, a system for obtaining a printed copy of a copyrighted or confidential document via the Internet is provided. The copyrighted/confidential document is encrypted at a server using a particular public encryption key. The encrypted document is then transmitted to a destination printer. The destination printer includes a private encryption key which corresponds to the public encryption key. The private encryption key is unavailable outside the printer. For example, a client computer attached to the printer may not read the private encryption key. Once the encrypted document is received, the printer decrypts the copyrighted/confidential document inside the printer prior to printing in order to frustrate redistribution of the copyrighted/confidential document.

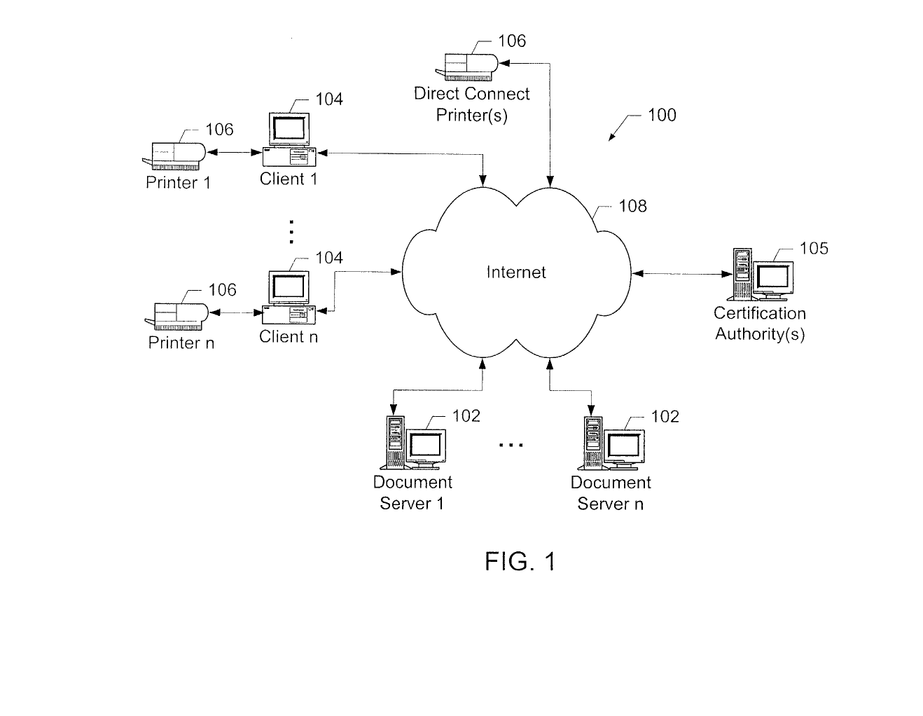

A high level block diagram of a communications system 100 employing an embodiment of the present invention is illustrated in FIG. 1. Typically, the system 100 includes one or more document servers 102, one or more client devices 104, at least one certification authority 105, and one or more printers 106. Each of these components may communicate with each other via any communication medium, such as a connection to the Internet or some other wide area network 108. Some printers 106 are connected directly to the network 108. Other printers 106 are connected to the network 108 indirectly via a client device 104. In one embodiment, each client device 104 is a personal computer or an Internet terminal. However, a person of ordinary skill in the art will readily appreciate that any type of client device 104 may be used. For example, an e-book, a personal digital assistant (PDA), a net phone, a network interface device, etc., could be used.

Typically, document servers 102 store a plurality of copyrighted documents, confidential documents, non-copyrighted documents, and/or non-confidential documents for delivery to one or more printers 106. In addition, document servers 102 may store other files, programs, and/or web pages for use by the document servers 102, client devices 104, and/or certification authority 105. One server 102 may handle requests from a large number of clients 104. Accordingly, each server 102 is typically a high end computer with a large storage capacity, one or more fast microprocessors, and one or more high speed network connections. However, a person of ordinary skill in the art will readily appreciate that any type of sever 102 may be used. For example, an e-book, a personal digital assistant (PDA), a net phone, a network interface device, etc., could be used. Conversely, relative to a typical server 102, each client 104 typically includes less storage capacity, a single medium to high speed microprocessor, and a single medium speed network connection. The certification authority 105 may be used to facilitate public key encryption functions described in detail below. However, the certification authority is optional.

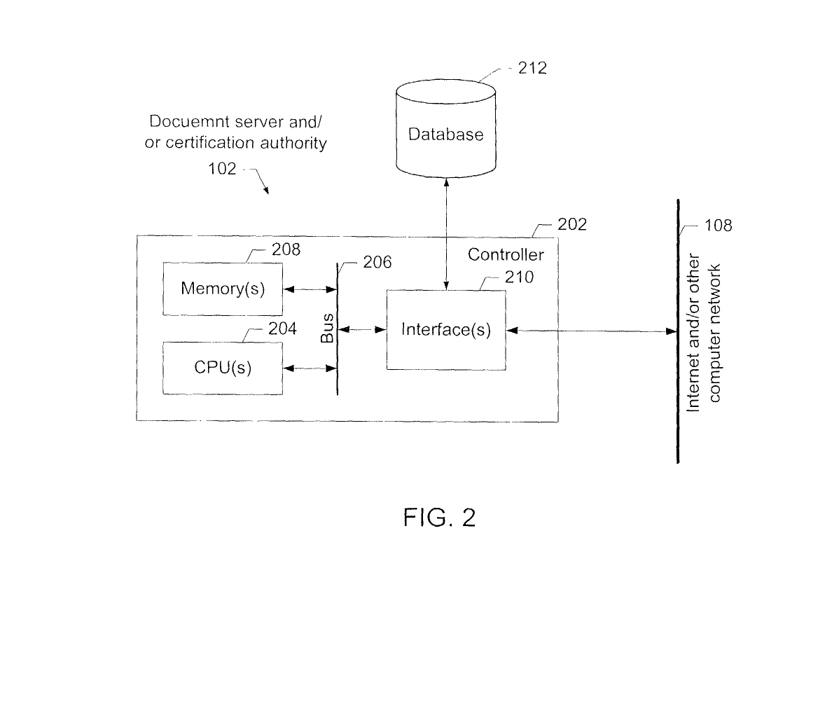

A more detailed block diagram of a document server 102 (and/or a certification authority) is illustrated in FIG. 2. A controller 202 in the server 102 preferably includes a central processing unit 204 electrically coupled by an address/data bus 206 to a memory device 208 and a network interface circuit 210. The CPU 204 may be any type of well known CPU, such as an Intel Pentium™ processor. The memory device 208 preferably includes volatile memory, such as a random-access memory (RAM), and non-volatile memory, such as a read only memory (ROM) and/or a magnetic disk. The memory device 208 stores a software program that implements all or part of the method described below. This program is executed by the CPU 204, as is well known. However, some of the steps described in the method below may be performed manually or without the use of the server 102.

The memory device 208 and/or a separate database 212 also store digital data indicative of copyrighted/confidential documents, non-copyrighted/non-confidential documents, files, programs, web pages, etc. for use by one or more devices connected to the network 108. One or more copyrighted/confidential documents may be stored in an encrypted format, or a non-encrypted format. Preferably, non-encrypted copyrighted/confidential documents are encrypted by the CPU 204 before delivery to a printer 106 as described in detail below.

The server 102 may exchange data with other devices via a connection to the network 108. The network interface circuit 210 may be implemented using any data transceiver, such as an Ethernet transceiver. The network 108 may be any type of network, such as a local area network (LAN), wide area network (WAN), wireless network, and/or the Internet.

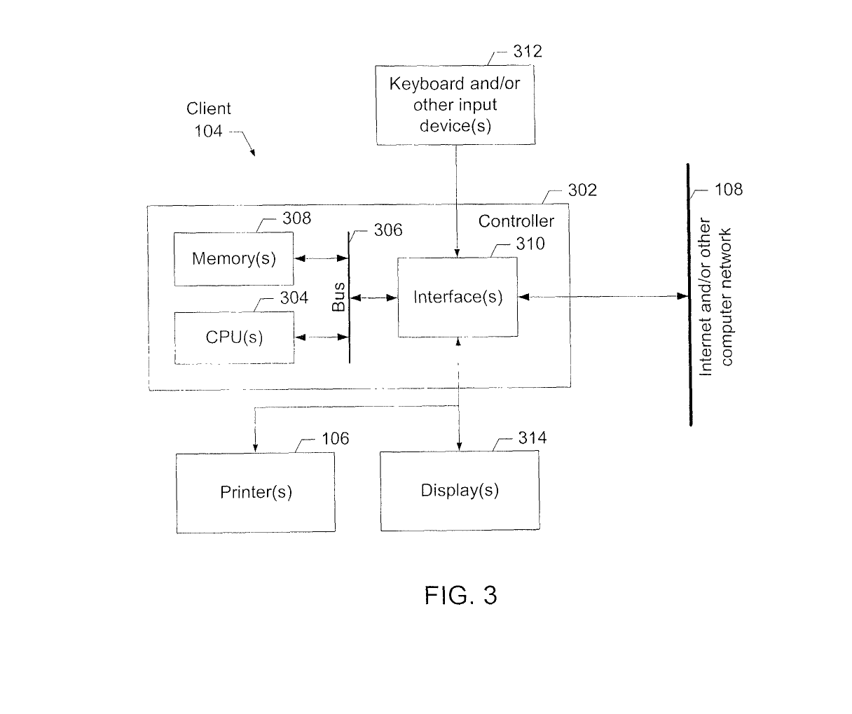

A more detailed block diagram of a client device 104 is illustrated in FIG. 3. Like the server 102, the client 104 includes a controller 302 which preferably includes a central processing unit 304 electrically coupled by an address/data bus 306 to a memory device 308 and an interface circuit 310. Again, the CPU 304 may be any type of well known CPU, such as an Intel Pentium™ processor, and the memory device 308 preferably includes volatile memory and non-volatile memory. However, as discussed above, the CPU 304 and/or memory device 308 associated with a typical client 104 may not be as powerful as the CPU 204 and/or memory 208 associated with a typical server 102. Like the server 102, the memory device 308 associated with the client 104 stores a software program that implements all or part of the method described below. This program is executed by the CPU 304, as is well known. However, some of the steps described in the method below may be performed manually or without the use of the PC 104.

The memory device 308 may also store digital data indicative of copyrighted/confidential documents, non-copyrighted/non-confidential documents, files, programs, web pages, etc. retrieved from a server 102 and/or loaded via an input device 312. Preferably, copyrighted/confidential documents are stored in the client memory 308 in an encrypted format. By limiting client storage of copyrighted/confidential documents to encrypted versions of the copyrighted/confidential documents, subsequent “sharing” of the copyrighted/confidential documents is of limited value if the recipient is unable to decrypt the document.

The interface circuit 310 may be implemented using any type of well known interface standard, such as an Ethernet interface, a Universal Serial Bus (USB) interface, and/or a wireless interface such as a Bluetooth radio interface or an infrared interface. Alternatively, a proprietary interface may be used. One or more input devices 312 may be connected to the interface circuit 310 for entering data and commands into the controller 302. For example, the input device 312 may be a keyboard, mouse, touch screen, track pad, track ball, isopoint, and/or a voice recognition system. In addition, a bar-code reader may be attached to convert bar-code symbols on printed documents into Internet address.

One or more printers 106 or other output devices may also be connected to the controller 302 via the interface circuit 310. The printer 106 is used to decrypt and print encrypted documents received from a document server 102. Preferably, decryption does not take place inside the client 104. In addition, a display 314 is preferably connected to the controller 302 via the interface circuit 310. The display 314 may be a cathode ray tube (CRT), liquid crystal displays (LCD), or any other type of display. The display 314 generates visual displays of data generated during operation of the client 104. The visual displays may include prompts for human operator input, run time statistics, calculated values, detected data, etc.

The client 104 may also exchange data with other devices via a connection to the network 108. The network connection may be any type of network connection, such as an Ethernet connection, digital subscriber line (DSL), telephone line, coaxial cable, wireless connection, etc. Users of the system may be required to register their printer 106. In such an instance, each user may choose a user identifier and a password which may be required for the activation of services. The user identifier and password may be passed across the Internet using encryption built in to the user's browser. Alternatively, the user identifier and/or password may be assigned by a server 102 or a certification authority 105.

The registration process may also collect billing and other user information. For example, a credit card number for print transactions may be collected. Demographic information such as name, address, age, etc. may be collected during registration and subsequently associated with purchased content for marketing purposes.

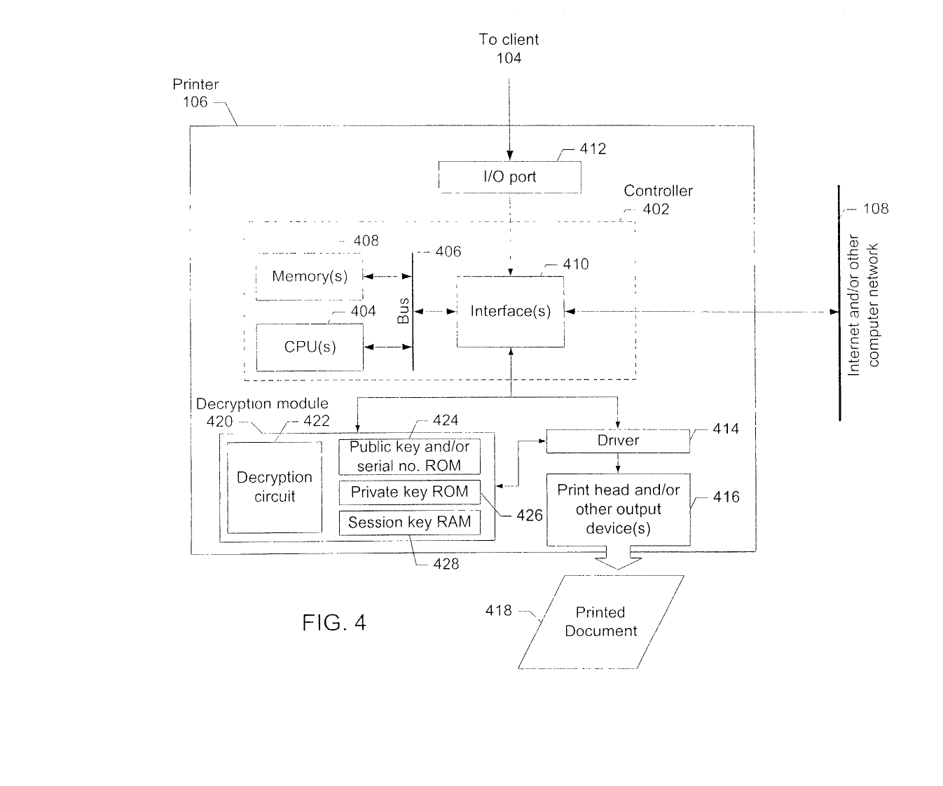

A more detailed block diagram of a printer 106 is illustrated in FIG. 4. The printer may be any type of printer, such as an ink jet printer, a laser printer, a digital copier, a digital printing press, etc. In addition, as used herein, the printer 106 may be replaced with any output device such as a printing press plate maker, a film recorder, or a display device such as a cathode ray tube or liquid crystal display. Preferably, the printer 106 includes a controller 402 which preferably includes a central processing unit 404 electrically coupled by an address/data bus 406 to a memory device 408 and an interface circuit 410. Again, the CPU 404 may be any type of well known CPU, such as an Intel Pentium™ processor, and the memory device 408 preferably includes volatile memory and non-volatile memory. However, the CPU 404 and/or memory device 408 associated with a typical printer 106 may not be as powerful as the CPU 304 and/or memory 308 associated with a typical client 104. For example, the printer 106 may employ a microcontroller to implement the CPU 404 and a portion of the memory 408. The memory device 408 associated with the printer 106 stores a software program that implements all or part of the method described below. This program is executed by the CPU 404, as is well known. However, some of the steps described in the method below may be performed manually or without the use of the printer 106. The memory device 408 may also store digital data indicative of copyrighted/confidential documents, non-copyrighted/non-confidential documents, files, programs, web pages, etc. retrieved from a server 102 either directly or indirectly via a client 104.

The interface circuit 410 may be implemented using any type of well known interface standard, such as an Ethernet interface, a Universal Serial Bus (USB) interface, and/or a wireless interface such as a Bluetooth radio interface or an infrared interface. Alternatively, a proprietary interface may be used. One or more input/output ports 412 may be connected to the interface circuit 410 for entering print data and print commands into the controller 402 from an attached client 104. The printer 106 may also receive print data and print commands from servers 102 via a connection to the network 108. The network connection may be any type of network connection, such as an Ethernet connection, digital subscriber line (DSL), telephone line, coaxial cable, etc.

The received print data may be encrypted or non-encrypted. When non-encrypted print data is received, the printer 106 preferably routes the non-encrypted print data to a driver 414. The driver 414 converts the non-encrypted print data into control signals for a print head 416 (or other printing mechanism) in a well known manner. The print head 416 then produces a paper version 418 of the document.

When encrypted print data is received, the printer 106 preferably routes the encrypted print data to a decryption module 420. The decryption module 420 preferably includes a decryption circuit 422, a public key 424 and/or a printer identifier (e.g., a serial number) stored in a read only memory, a private key 426 stored in a read only memory, and a session key 428 stored in a random access memory. In one embodiment, some or all of the decryption module 420 may reside on a smartcard. Of course, a person of ordinary skill in the art will readily appreciate that the decryption circuit 422, the public key ROM 424, the private key ROM 426, and the session key RAM 428 need not physically reside together. For example, the session key RAM 428 may be part of the controller memory 408. In addition, the decryption circuit 422 may be implemented as software stored in memory 408 and executed by the CPU 404 as is well known. Still further, the public key 424, the private key 426, and the session key 428 may be stored in any type of memory. However, in the preferred embodiment, the private key 426 is not readily accessible outside the printer 106. For example, the client 104 is preferably unable to retrieve the private key 426 from the printer 106.

In addition, the private key 426 may be stored in a tamper resistant enclosure, embedded in a replaceable ink cartridge, and/or stored on a smartcard. By storing the private key 426 in a replaceable ink cartridge, the number of pages that may be printed using a particular private key 426 is limited. Preferably, the ink cartridges are not refillable. In this embodiment, the ink cartridge preferably includes a unique identifier such as a serial number or the public key 424 associated with the private key 426 to ensure that it is not used for printing publications beyond a specific print life. In the event a smartcard is used to house the decryption circuit 422, the public key 424, the private key 426, and/or a session key 428, the smartcard is preferably electronically secure and/or tamper resistant. In addition, the smartcard may be used to facilitate electronic payments. For example, the smartcard may contain an account code and/or electronic cash which may be used to pay for ordered documents.

When the decryption module 420 receives encrypted print data, the decryption circuit 422 converts the encrypted print data into non-encrypted print data. In one embodiment, the encrypted print data includes the entire document encrypted with the public key 424. In such an instance, the decryption circuit 422 uses the private key 426 to decrypt the entire document. In another embodiment, the encrypted print data includes a session key 428 encrypted with the public key 424 and the document encrypted with the session key 428. In such an instance, the decryption circuit 422 uses the private key 426 to decrypt the session key 428 and the decrypted session key 428 to decrypt the document. Of course, a person of ordinary skill in the art will readily appreciate that the encrypted session key 428 and the encrypted document may be received separately. By using a symmetric session key 428, the encrypted document may be decrypted faster than the same document encrypted using an asymmetric public key encryption system. In addition, the encrypted document may be smaller, thereby requiring less storage and transmitting faster In one embodiment, a new session key 428 is generated for each print job.

Once the decryption circuit 422 converts the encrypted print data into non-encrypted print data, the decryption module 420 passes the decrypted data to the driver 414. As described above, the driver 414 converts the non-encrypted print data into control signals for a print head 416 (or other printing mechanism) and produces a paper version 418 of the document in a well known manner.

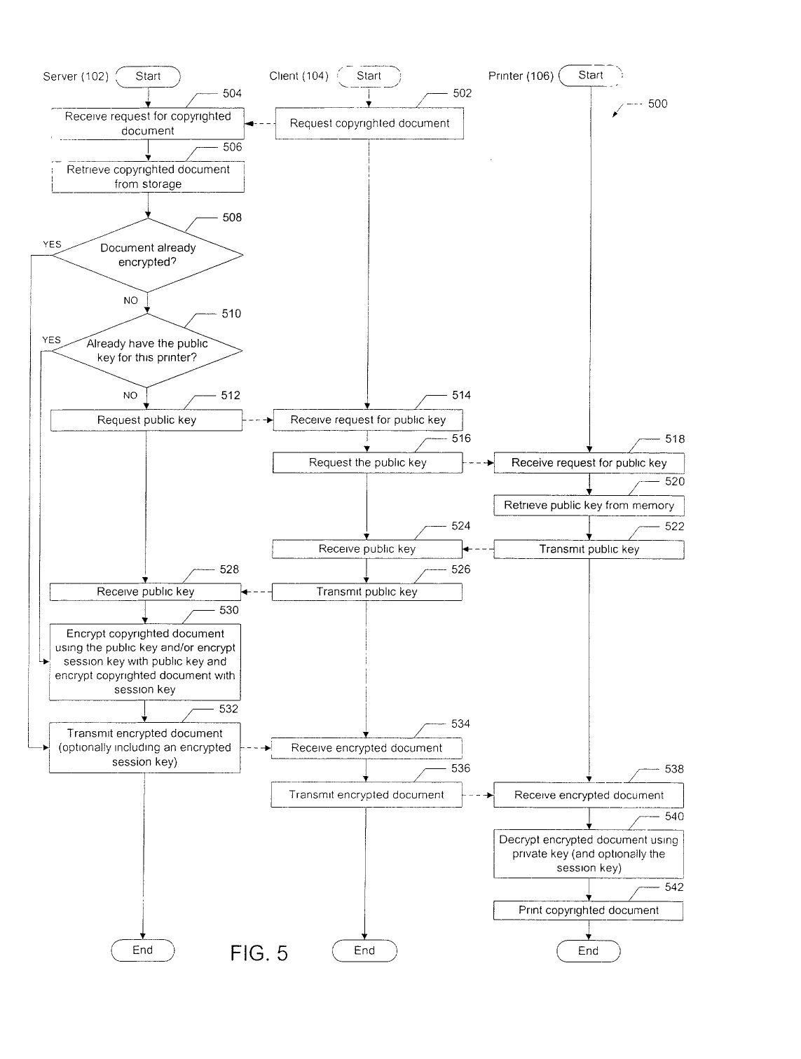

A flowchart of a process 500 for transmitting a copyrighted/confidential document from a content server 102 to a printer 106 via a client device 104 is illustrated in FIG. 5. Preferably, a first portion of the process 500 is embodied in a software program which is stored in the printer memory 408 and executed by the printer CPU 404 in a well known manner. A second portion of the process 500 is preferably embodied in another software program which is stored in the client memory 308 and executed by the client CPU 304 in a well known manner. Similarly, a third portion of the process 500 is preferably embodied in yet another software program which is stored in the server memory 208 and executed by the server CPU 204 in a well known manner. However, some or all of the steps of the process 500 may be performed by another device. Further, one or more of the steps of the process 500 may be performed manually without the use of a CPU.

Generally, the process 500 transmits a copy of a copyrighted/confidential document from a document server 102 to a printer 106 via the Internet. The copyrighted/confidential document is encrypted at the server 106 using a particular public encryption key 424. The encrypted document is then transmitted to the destination printer 106. The destination printer 106 includes a private encryption key 426 which corresponds to the public encryption key 424. The private encryption key 426 is generally unavailable outside the printer 106. For example, if a client 104 is attached to the printer 106, the client 104 is preferably unable to read the private encryption key 426 from the printer 106. Once the encrypted document is received by the printer 106, the printer 106 decrypts the copyrighted/confidential document inside the printer 106 prior to printing in order to frustrate redistribution of the copyrighted/confidential document.

The process 500 begins when the client 104 transmits a request for a copyrighted/confidential document to the server 102 via the network 108 (step 502). Optionally, the request includes the public key 424 and/or a printer identifier (e.g., a serial number) associated with the attached printer 106. The request may be for one or more copyrighted/confidential documents selected by a user, or the request may be for one or more copyrighted/confidential documents automatically selected for the user based on a user profile. For example, the user may select a particular copyrighted/confidential document after browsing a plurality of document descriptions including titles, summaries, lengths, creation dates, prices, etc. Automatic selection based on a user profile may be performed by the client 104 and/or the server 102. In one embodiment, the document is never requested. Instead the server 102 “pushes” the document to the client 104.

Once the document request is received by the server 102 (step 504), the server 102 retrieves the requested document(s) from the database 212 (step 506). The server 102 then determines if the document is already encrypted (step 508). For example, if a user requests more than one copy of a document, the document may already be encrypted using that user's public key 424. In another example, a plurality of printers 106 may contain the same private key 426 for mass distribution of a publication. If the document is not already encrypted, the server 102 determines if memory 208 already has a copy of the public key 424 associated with the printer 106 which is attached to the client 104 (step 510). For example, the server 102 may retrieve a copy of the public key 424 from memory 208 based on a unique identifier associated with the printer 106. In another example, the server 102 may be servicing additional requests from a printer 106 as part of a communication session with that printer 106, whereby the public key 424 associated with the printer 106 was determined earlier in the communication session. If memory 208 does not already have a copy of the public key 424 associated with the printer 106, the server 102 preferably transmits a request for the public key 424 to the client 104 via the network 108 (step 512).

Alternatively, the server 102 may transmit the request for the public key 424 directly to the printer 106 or to the certification authority 105. If a certification authority 105 is used, some identifier associated with the printer 106 is preferably transmitted along with the public key request. For example, a serial number, a user name, or a network address may be used to identify the printer 106. The certification authority 105 may digitally sign and/or encrypt the retrieved public key 424 prior to transmission to the server 102. In this manner, only public keys 424 actually associated with an authorized printer 106 are used, thereby preventing circumvention of the system using a rogue public/private key pair.

Returning to FIG. 5, once the public key request is received by the client 104 (step 514), the client 104 preferably transmits a request for the public key 424 to the printer 106 via the interface circuit 310 (step 516). Alternatively, the client 104 may have a copy of the public key 424 stored locally in memory 308. If the client 104 has a copy of the public key 424 stored locally in memory 308, there is no need to request a copy of the public key 424 from the printer 106. The public key 424 may be stored in the client memory 308 in any manner. For example, the client 104 may retain a copy of the public key 424 during a previous communication from the printer 106, or the client 104 may receive a copy of the public key 424 from a disk or the certification authority 105 during a setup procedure.

Once a request for the public key 424 is received by the printer 106 (step 518), the printer 106 retrieves the public key 424 from memory (step 520). The memory storing the public key 424 may be a read only memory specifically designed to hold the public key 424 or the memory storing the public key 424 may be the main memory 408 associated with the printer 106. The printer 106 then transmits the public key 424 to the client 104 via the input/output port 412 (step 522).

Once the public key 424 is received by the client 104 (step 524), the client 104 transmits the public key 424 to the server 102 via the network 108 (step 526). Once the public key 424 is received by the server 102 (step 528), the server 102 preferably verifies that the public key 424 is a valid public key 424. For example, the server 102 may check the received public key 424 against a list of public keys 424 previously determined to be actually associated with an authorized printer 106. In this manner, circumvention of the system using a rogue public/private key pair is prevented. If the public key 424 is valid, the server 102 may encrypt the copyrighted/confidential document using the public key 424 (step 530). Of course, if the server 102 determined that a copy of the public key 424 was locally available at step 510, steps 512-528 would be unnecessary.

In one embodiment, to encrypt the copyrighted/confidential document using the public key 424, the entire copyrighted/confidential document is encrypted with the public key 424 in a well known manner. In another embodiment, to encrypt the copyrighted/confidential document using the public key 424, a session key 428 is encrypted with the public key 424, and the copyrighted/confidential document is encrypted with the session key 428 in a well known manner. Preferably, the public key 424 is an asymmetric key corresponding to the private key 426 embedded in the printer 106. However, the session key 428 is preferably a symmetric key generated by the server 102. By using a symmetric session key 428 to encrypt the document instead of an asymmetric public key 424, the document may be encrypted more quickly and/or the encrypted file may be smaller.

Regardless of the method of encryption, once the document to be printed is encrypted (step 530), the server 102 transmits the encrypted document to the client 104 via the network 108 (step 532). If used, the encrypted session key 428 may be transmitted before the encrypted document, with the encrypted document, or after the encrypted document. Once the encrypted document is received by the client 104 (step 534), the client 104 transmits the encrypted document to the printer 106 via the interface circuit 310 (step 536).

Once the encrypted document is received by the printer 106 (step 538), the printer 106 decrypts the encrypted document using the private key 426 embedded in the decryption module 420 (step 540). In one embodiment, the entire copyrighted/confidential document is encrypted with the public key 424. In such an instance, the entire copyrighted/confidential document is decrypted with the private key 426. In another embodiment, a session key 428 is encrypted with the public key 424, and the copyrighted/confidential document is encrypted with the session key 428. In such an instance, the session key 428 is decrypted with the private key 426, and the document is decrypted with the decrypted session key 428. Once the document is decrypted by the printer 106, the printer 106 preferably prints the document in a well known manner (step 542).

In one embodiment, portions of the copyrighted/confidential documents are encrypted, decrypted, and/or printed separately. For example, the document may be divided at page breaks or some other point to create a plurality of documents. In another example, the entire document is transmitted as one whole. However, decryption and/or printing occurs in a streaming fashion (i.e., before the entire document arrives) in order to expedite the printing process.

In summary, persons of ordinary skill in the art will readily appreciate that a method and apparatus for obtaining a printed copy of a copyrighted/confidential document via the Internet has been provided. Systems implementing the teachings herein may decrypt a copyrighted/confidential document inside a printer in order to frustrate redistribution of the copyrighted/confidential document.

The foregoing description has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended hereto.

What is claimed is:

1. A method for obtaining a printed copy of a document at a printer from a server via a client, the method comprising the steps of:
installing a private encryption key in the printer, the private encryption key being unavailable to the client and the server;
providing the server with a public encryption key, the public encryption key being associated with the private encryption key, the public encryption key being different than the private encryption key;
receiving an encrypted file at the printer from the server via the client, the encrypted file being encrypted using the public encryption key;
generating decrypted data associated with the document by decrypting the encrypted file in the printer using the private encryption key; and
printing the document at the printer using the decrypted data.

2. A method as defined in claim 1, wherein the step of installing a private encryption key in the printer comprises the step of installing the private encryption key in a tamper resistant electrical module.

3. A method as defined in claim 1, wherein the step of installing a private encryption key in the printer comprises the step of installing the private encryption key in a replaceable ink cartridge.

4. A method as defined in claim 1, wherein the step of providing the server with a public encryption key comprises the step of retrieving the public encryption key from the printer.

5. A method as defined in claim 1, wherein the step of providing the server with a public encryption key comprises the step of transmitting the public encryption key from the client to the server.

6. A method as defined in claim 1, wherein the step of providing the server with a public encryption key comprises the step retrieving the public encryption key based on a unique identification code associated with the printer.

7. A method as defined in claim 1, wherein the step of providing the server with a public encryption key comprises the step retrieving the public encryption key based on a unique identification code associated with a print cartridge.

8. A method as defined in claim 1, wherein the step of providing the server with a public encryption key comprises the step retrieving the public encryption key from a certification authority based on a serial number retrieved from the printer.

9. A method as defined in claim 1, wherein the step of providing the server with a public encryption key comprises the step retrieving the public encryption key from a certification authority based on a serial number retrieved from a print cartridge.

10. A method as defined in claim 1, further comprising the step of transmitting a request for the encrypted file from the client to the server.

11. A method as defined in claim 1, wherein the step of generating decrypted data associated with the document by decrypting the encrypted file in the printer using the private encryption key comprises the step of using the private encryption key indirectly by:
using the private encryption key to decrypt an encrypted session key; and
decrypting the encrypted file using the decrypted session key.

12. A method as defined in claim 1, wherein the step of generating decrypted data associated with the document by decrypting the encrypted file in the printer using the private encryption key comprises the step of decrypting the entire encrypted file using the decrypted symmetric encryption key directly.

13. A printer for printing a copyrighted document based on encrypted data received via the Internet, the printer comprising:
a communication port operatively coupled to the Internet;
a memory device storing an embedded encryption key, the embedded encryption key being unavailable outside the printer;
a decryption module electrically coupled to the communication port and the memory device, the decryption module being adapted to receive an encrypted version of the copyrighted document via the communication port, the decryption module being adapted to convert the encrypted version of the copyrighted document into decrypted data indicative of the copyrighted document using the embedded encryption key; and
a printing mechanism operatively coupled to the decryption module, the printing mechanism being adapted to receive the decrypted data and print the copyrighted document based on the decrypted data.

14. A printer as defined in claim 13, wherein the communication port is electrically coupled to a client device.

15. A printer as defined in claim 13, wherein the communication port is electrically coupled to a document server via the Internet.

16. A printer as defined in claim 13, wherein the embedded encryption key comprises an asymmetric private encryption key.

17. A printer as defined in claim 13, wherein the embedded encryption key comprises an symmetric session key.

18. A printer as defined in claim 13, further comprising a controller operatively coupled to the communication port and the printing mechanism, the controller being adapted to receive non-encrypted data indicative of a non-copyrighted document from the communication port, the controller being adapted to transmit control signals to the printing mechanism to print the non-copyrighted document.

19. A printer as defined in claim 13, wherein the decryption module comprises a tamper resistant housing.

20. A printer as defined in claim 13, wherein the decryption module comprises a replaceable ink cartridge.

21. A printer as defined in claim 20, wherein the replaceable ink cartridge comprises a tamper resistant housing.

22. A printer as defined in claim 20, wherein the private key is inaccessible outside the replaceable ink cartridge.

23. A printer as defined in claim 13, wherein the decryption module comprises a smartcard.

24. A printer as defined in claim 13, wherein the memory device stores a public encryption key, the public encryption key being electronically accessible via the communication port.

25. A printer as defined in claim 13, wherein the memory device stores a serial number, the serial number being electronically accessible via the communication port.

26. A printer as defined in claim 13, wherein the decryption module is adapted to receive an encrypted session key from the communication port, the decryption module being adapted to decrypt the encrypted session key using the embedded encryption key, the decryption module being adapted to employ the decrypted session key during conversion of the encrypted version of the copyrighted document into decrypted data.

27. A printer as defined in claim 13, wherein the printing mechanism comprises a plate maker.

28. A printer as defined in claim 13, wherein the printing mechanism comprises a film recorder.
